(19) United States
(12) Patent Application Publication
(10) Pub. No.: US 2003/0120578 A1
(43) Pub. Date: Jun. 26, 2003

(54) System and methods for electronic securities underwriting and electronic dissemination of annual financial and disclosure information from issuers to information repositories in accordance with U.S. securities laws and regulations

(76) Inventor: Peter Newman, Brooklyn, NY (US)

Correspondence Address: CLARK & BRODY, Suite 600, 1750 K Street, NW, Washington, DC, 20006, US

(21) Appl. No.: 10/326,120

(22) Filed: Dec. 23, 2002

Related U.S. Application Data
(60) Provisional application No. 60/342,342, filed on Dec. 21, 2001.

(51) Int. Cl. G06F 17/60

(52) U.S. Cl. 705/36

(57) ABSTRACT

The present invention provides systems and methods for electronic underwriting of new offerings of securities in the primary market for municipalities, institutions and corporations in accordance with U.S. securities laws and regulations. The system also provides a method for those issuers to electronically disseminate annual financial information on existing securities in the secondary market to information repositories. The user can fulfill disclosure requirements for a new offering of securities by completing various forms stored on the system, including the prospectus, closing memorandum, legal opinion and purchase contract. The issuer can fulfill its disclosure obligations for existing offerings of securities by completing various forms, including secondary market disclosure forms, material events notices and financial reports such as annual reports and earnings reports. After completing the forms, the user can disseminate the information electronically to information repositories.

This application claims priority under 35 USC 119(e) based on provisional application No. 60/342,342 filed on Dec. 21, 2001.

### FIELD OF THE INVENTION

This invention relates to a system and method for underwriting new offerings for securities and dissemination of annual financial and disclosure information for municipalities to meet secondary market requirements. The system and method employ an external data interface means that receives and processes underwriting and disclosure information from users which is delivered to a server which receives, stores, processes and creates documentation to fulfill industry requirements for underwriting, disclosure and compliance.

### BACKGROUND ART

There is arguably nothing more important to the health of a nation than a strong public finance system. In the U.S., more schools, city halls, water and sewer systems, fire stations, airports and stadiums are being built to meet the demands of a larger populace. Over the last few years, many cities such as Cleveland, Seattle, Denver, Detroit and San Francisco have used tax-free bonds to finance new high-tech stadiums to replace old and worn-out facilities. Other municipalities have upgraded or repaired their existing infrastructure to accommodate new users. Examples include smaller cities like North Bend and Burlington, Wash. that have rehabilitated their existing water and sewer systems. With many regions of America still growing, this building trend will continue. With interest rates near 25-year lows, it is currently cost-effective for municipalities to issue bonds. Clean water and good schools are absolutely critical to a healthy economy and society.

Municipal finance unites three separate groups that together work to build public works projects that benefit local citizens: individual municipalities such as universities, states, counties, cities and smaller taxing districts (i.e. school districts, fire districts, hospitals) that issue bonds; Finance Team members such as underwriters, attorneys and financial advisors that prepare required documentation for each new issue; and investors (usually clients of the underwriter or large institutions) that purchase the bonds.

The bond proceeds are used to build new facilities or to replace old ones, and to pay the financing costs of the bond issue. The bond issuer pays each investor tax-free interest for a specific period of time, plus the original principal amount when the bonds mature. Depending on the type of municipality, investors are paid with tax collections or revenues from a specific entity under the municipality's control, such as a utility system. Both long-term bonds and short-term notes are available to municipalities based on their financing needs and ability to pay debt service. Long-term debt instruments include: general obligation bonds (paid by tax collections) and revenue bonds (paid by utility revenues). Short-term notes (usually no longer than 13 months) include: tax anticipation notes (TANs), revenue anticipation notes (RANs), bond anticipation notes (BANs) and grant anticipation notes (GANs). In 1999, approximately 12,350 long-term bonds and 3,650 short-term notes were issued, totaling $255.2 billion.

Depending on the way each bond issue is structured, bonds may be “called” (redeemed) after a certain time period to help the issuer take advantage of refinancing opportunities. For example, if bonds were issued at a high interest rate during an inflationary period in America (1970s) and then rates fell (1990s), the issuer could refinance the existing debt at the lower current rate, resulting in a savings for the municipality. Individuals take advantage of home refinancing opportunities in the same way. The result is that in a falling interest rate environment, new bonds are issued more cheaply and existing debt is refinanced.

Once bonds are issued, a municipality must pay interest regularly (usually semi-annually) to each investor. The bond prospectus, known as the Preliminary Official Statement, is used to attract investors for the new issue. The prospectus document becomes the Official Statement (the governing public finance document) when the issue is finalized. The Official Statement serves as the contract between the issuer and the bondholder dictating the terms of the financing, the ability of the issuer to repay debt, the tax status of the debt, and other critical information.

This document states that the issuer agrees to pay an investor a set interest rate for a given maturity of bonds. It also provides the investor with information on the issuer, its organizational structure, financial status, debt payment history and information on the local economy, tax base, regional employers and demographic information that impact the issuer's tax and revenue collections. As part of its contract to bondholders, the issuer must disclose to investors on an annual basis financial information in the form of annual reports and material events (bond calls, principal or payment delinquencies, defaults, rating changes etc). Public corporations have similar obligations and issue regular quarterly and annual reports. Other documents that outline the tax status of the bonds, the legal opinion on the debt and the method of pricing and transfer of proceeds, together with the prospectus and Official Statement, make up the bond transcript. The bond attorney compiles a transcript for each new issue of municipal securities that enters the primary market.

Over the last few years, the municipal bond industry and its self-regulatory organization, the Municipal Securities Rulemaking Board (MSRB) have tried to address the complex subject of disclosure and to agree on certain standards for it. Hundreds of municipal websites have been set up in part to improve disclosure and build public awareness of municipal activities. Trade publications and conferences have made issuers more aware of their responsibilities to their bondholders as well as to their taxpayers. The municipal industry, long known for its conservatism, took an important step when it embraced document posting in photo document format (PDF) format via the Internet as an alternative to paper distribution. Agencies now accept continuing disclosure forms through the web, as well as in paper form, for bonds in the secondary market.

While some steps to automate the municipal bond industry have been taken, particularly on the “sell” side, the document-creation process is still laborious and time-consuming. Sometimes disclosure in the Preliminary Official Statements is compromised in an attempt to get the bonds to market. There are inconsistent disclosure policies, various methods of distribution, and few standardized methods and forms for collecting issuer-specific data. The Bond Buyer reported in 1999 and 2001 that many issuers are still not complying with secondary market disclosure requirements, largely because there is no standardized template for the information.

Efficient handling of large amounts of data and necessary documentation is difficult because each issue requires a mountain of supporting paperwork. There are more than 10 types of municipal bond issues, each requiring a different format for the Official Statement. Many Finance Team members are overworked because of the complexities involving each municipal issue. The industry is behind the curve when it comes to using data-automation techniques and software to handle data management and document creation.

Currently four parties (underwriter, underwriter's counsel, bond attorney and/or financial advisor) create new Preliminary and Final Official Statements by using an existing bond issue as a template (made up of text and spreadsheet files), and then cutting and pasting text and data into the template. In addition, underwriters and attorneys have other sets of documents they must complete for each new bond issue included at the deal's end in the bond transcript. These parties generally use the Microsoft Office® platform (including Word and Excel programs) to structure the documents.

The Microsoft Office® platform has several problems and limitations: (1) the data in these files is not in database form, and therefore cannot be updated, stored or manipulated efficiently; (2) the user cannot take full advantage of XML technologies that help automate the laborious document-creation process; (3) no tracking system exists that identifies what persons are responsible for collecting and updating specific data, and when it has been most recently updated; (4) multiple users cannot access the same Word or Excel files at the same time on a network to update the documents in a transactional format; (5) the template may not be the best one available for the document; and (6) the Windows platform is not designed to retain institutional memory to assist with training and new issue creation.

In the earliest stages of the underwriting process, the author requests information from the issuer, local county, city, and/or district offices, chambers of commerce, information bureaus and governmental institutions. The data is then input into the prospectus using standard text management and spreadsheet applications.

Problems and inefficiencies exist in the data-gathering process and methodology. Requesting detailed information by fax, email and telephone, and subsequent data-entry is often inefficient and expensive, i.e., faxed requests or responses may be unreadable, contact information may be incorrect, document-turnaround is delayed because of need to corroborate data, and data entry errors may occur, sometimes resulting in compromised disclosure documents.

If requested information is unavailable, or out of date, pricing the bond issue, and then delivering the proceeds may have to be postponed. This delay may end up costing the issuer money, depending upon the size of the issue and the movement of interest rates. Related construction delays might occur as a result, causing difficulties for citizens and officials at the local level.

If turnover happens within the financing team, valuable institutional information may be lost in the process.

Once a bond has been issued, in most instances the issuer and its dissemination agent (either the issuer itself or its certified public accounting firm) must file required disclosure materials annually, and in the case of material events, report these to the correct repositories and agencies. Depending on the issuer and the type of bond issued, the quality and amount of disclosed material required varies greatly. The agent also creates the annual report and financial statements for the municipality.

There are a number of problems in the municipal secondary market in terms of handling municipal disclosure filings. Public companies use the EDGAR® system to file quarterly reports and disclose material information all in an electronic format. The municipal industry has no such standardized system to accept electronic reports, therefore issuers and dissemination agents use various methods and forms to complete secondary filings. Almost 90% of these filings are in paper format.

Investor relations efforts are greatly hampered because the municipal industry lacks a standardized system like EDGAR® that accepts information on a quarterly basis (or more frequently as material events occur). With the exception of municipal issuers in the healthcare sector, issuers disclose information on an annual basis and this information is often out of date by the time the investor sees it.

Lack of standardization in the filing process means that many of the filings Nationally Recognized Municipal Securities Information Repositories (NRMSIR's) receive are incomplete and therefore not very useful to data providers or the investment community. Investors are demanding more timely information in a usable format, and the lack of standardization and electronic reports hurts this objective.

NRMSIRs are receiving information almost exclusively in paper format. Lack of electronic dissemination means more costs are being passed on to the issuers by their dissemination agents, or being absorbed by the issuers if the issuers are filing themselves. More paperwork means more data-entry and mailing costs related to each filing.

Issuers that are in charge of their own filings risk non-compliance when staff turnover occurs at the municipal level because these issuers lack systems that preserve institutional memory. Because the municipal industry is self-regulated rather than being overseen directly by the Securities and Exchange Commission (SEC) and National Association of Security Dealers (NASD), non-compliance with filing requirements is not punishable directly and therefore non-compliance is not perceived as affecting the issuer in significant ways. However, both investors and issuers are paying the price for non-compliance via fines and the like. Issuers that are in compliance and disseminating updated financial information should see benefits in the marketplace.

The problems faced by the municipal industry are also faced by corporations that are involved in fixed income instruments (including corporate bonds for corps), institutions that are involved in mortgage-backed bonds such as FNMA and Freddie Mac, and others involved in equities.

### SUMMARY OF THE INVENTION

The present invention has met these needs by providing a computerized data processing system for creating, storing, disseminating and reporting disclosure and compliance information for municipalities, institutions and corporations. Internal database server means serves to receive and process data from users submitting information into the system. The data resides on the server and is in communication with the internal user interface. Internal user interface means resides on the application server and communicates with system users and the central database.

A user accesses the internal interface via an Internet connection and a web browser. The web browser interacts with the internal interface through an authentication engine that enhances the security of the system. The internal user interface accesses the central database and transmits data through the web browser to the user.

A plurality of users may be in communication with the main database through the internal user interface means simultaneously.

It is an object of the present invention to provide such a system which will permit the rapid and accurate computerized processing of documents and data related to a new issuance of securities, such as that involved in municipal bond transactions and corporate bond transactions, etc.

Users will draft documents within the system for new issues and can utilize templated documents within the system that conform to the bond industry's guidelines for disclosure. Once the bonds have been offered to investors for purchase (i.e. sold in the primary market as an initial public offering of securities) the securities can be resold again. They now exist in the secondary market and are subject to annual filing and compliance requirements associated with securities in the secondary market.

It is a further object of the present invention to provide such a system which will permit the rapid and accurate computerized processing of documents and data related to a secondary market security such as annual report filing, material event notification and filing, continuing disclosure filings per the SEC's Rule 15c2-12, for example.

It is a further object of the present invention to provide such a system which will permit the rapid and accurate reporting of documents and data related to a primary market and secondary market security.

The invention includes methods for electronic underwriting of new offerings of securities in the primary market in accordance with US securities laws and regulations for municipalities, institutions and corporations and electronically compiling and disseminating annual financial and disclosure information for existing offerings of securities in the secondary market in accordance with US securities laws and regulations for issuers of securities. The method is applicable to municipalities, corporations, institutions and the like that issue new offerings of securities as well as those that must adhere to secondary market obligations for the issued securities.

In one aspect, the method for electronic underwriting of new offerings of securities provides at least one server and a central database, the central database containing a plurality of forms as new offering templates and active new offering forms, the forms containing a number of data fields and content. An internal user interface is provided that is in communication with the server. The internal user interface is accessed via a global computer network using one or more authentication steps followed by at least one user. Once access is achieved, the user can select one of the forms and edit the selected form with one or more of data input from at least one user or data stored on the central database. The form can be stored on the central database for later editing or later dissemination to an interested party or at least one user.

The editing can comprise one or more of adding data fields to the form and entering data therein, inputting data into existing data fields in the form, or editing content of the form, and a number of forms can be edited if desired.

The form is derived from critical data elements for inclusion in the data field and is stored in a database format and content files stored on a file server in hypertext markup language (HTML), wherein an extensible markup language (XML) engine combines the content files and critical data elements to produce the form.

The work product developed for the new offering can be utilized when dealing in the secondary market. A plurality of disclosure forms are provided in the central database, the disclosure forms having information required once a new offering is completed. These disclosure forms can be edited using the information from the new offering. Advantageously, the method can link primary and secondary market tasks and obligations, so that information associated with the new offering is made available for secondary market disclosure obligations.

The system comprises a user interface means for creating, editing, and disseminating information relating to new offerings and annual financial and disclosure information relating to existing offerings of securities and a server means for storing said created and edited information in a central database supported by said server. The server means processes user input and user commands for creating, editing, and disseminating the information, the user interface means in communication with said server means for completing the information and delivering dissemination requests to the server means. The server means also has means for delivering to said user interface means the created and edited information stored in said central database, and means for allowing simultaneous access to said server means through said user interface means by a plurality of users. The user interface means also has electronically linked data fields means connecting to the server and said central database.

The server further comprises central database server and a file server, wherein data elements for creation of information are stored in the central database server, and documents for receiving the data elements for creation of the information are stored on the file server. The central database server stores templates related to new offerings and created information relating to new offerings and existing offerings, information related to new offerings accessible via the user interface means for creation of information related to existing offerings. The information created, edited, stored, and disseminated by the user interface means includes templates, templates with one or more of added or edited data elements, and existing offering forms with one or more of added or edited data elements.

### BRIEF DESCRIPTION OF THE DRAWINGS

Reference is now made to the drawings of the invention wherein:

FIGS. 1a and 1b are illustrations of application modules within the system.

FIG. 2 is an illustration of the new issue process and storage of information.

FIG. 3 is an illustration of the template process and storage of information.

FIG. 4 is an illustration of issue workflow.

FIG. 5 is an illustration of the XML engine.

FIG. 6 is an illustration of functional modules within the system.

FIG. 7 is a schematic diagram of a preferred embodiment of the present invention.

FIG. 8 is an illustration of the system architecture in the present invention.

FIG. 9 is an illustration of the system's administrative document ownership and account information protocols within the central database.

FIG. 10 is an illustration of the system's administrative document storage and organization protocols for templates within the central database.

FIG. 11 is an illustration of the system's administrative document storage and organization protocols for bond issues within the central database.

FIG. 12 is an illustration of the system's administrative security and user access protocols within the central database.

FIG. 13 is a screen shot illustration of a home page of a website showing panels for the transcript aspect of the system and method, and panels for navigation and to produce the desired output as it relates to primary market and secondary market requirements.

FIG. 14 is a screen shot illustration of a portion of an exemplary Official Statement as part of a new offering of a security.

FIG. 15 is a screen shot illustration showing text editing capability of the Official Statement.

FIG. 16 is a screen shot illustration of a listing of critical data elements.

FIG. 17 is a screen shot illustration of critical data fields capable of being edited.

FIG. 18 is a screen shot illustration showing adding critical data elements as an editing step.

FIG. 19 is a screen shot illustration of an exemplary disclosure form for editing for secondary market reporting obligations.

FIG. 20 is a screen shot illustration of an attach document page for editing a disclosure document.

FIG. 21 is a screen shot illustration of an issue calendar for tracking tasks associated with a given project.

FIG. 22 is a screen shot illustration of an underwriting checklist showing tasks associated with a given project.

FIG. 23 is a screen shot illustration of listing of tasks from the task manager for a given project.

FIG. 24 is a screen shot illustration relating to the contacts manager of the invention.

FIG. 25 is a screen shot illustration showing an actual contact page with information.

FIG. 26 is a screen shot illustration showing a note page in conjunction with a contact page.

### DESCRIPTION OF THE PREFERRED EMBODIMENTS

The present invention offers a number of solutions to the problems faced by entities that issue bonds, as well as the firms or entities acting as dissemination agents in the secondary market.

The present invention provides a complete document solution for public finance professionals that are bringing new municipal bonds to market; additionally the invention provides a complete disclosure solution for secondary market regulatory filings. The invention includes a suite of web-based applications designed specifically to automate much of the work involved in creating time-sensitive sets of documents for municipalities. With these web-based applications, municipalities and investment banking, legal, financial advising and accounting firms can compile, maintain and transmit disclosure documentation efficiently without sacrificing accuracy.

The invention provides a number of solutions to methods currently in use in both the primary market when issuing new bonds, and the secondary market where certain disclosure requirements must be met. Time-sensitive documents for municipalities on a proprietary web-based platform can be created to offer security, reliability, accountability, efficiency and provides cost-savings. Microsoft Office® applications are supported to coincide with the applications most used by those working in this environment. Multiple users are able to choose the best template available for a particular deal. Municipal documents can be effectively managed using a secure website, database and set of intuitive applications. Content can be developed and quickly updated by various members of a finance team. A contact management system can track users and recent updates to ensure that the right information is available whether the municipality is working on a bond issue, an annual report or continuing disclosure requirements. Standardizing the formats for issuer-specific data benefits all parties involved, including investors and regulatory bodies. A secure, centralized site acts as a reliable dissemination system to ensure consistent, high-quality disclosure every time.

In terms of issuing new bonds or other debt instruments, some of the advantages of the invention include:

The ability to select the best form for every Official Statement rather than choosing from older forms due to their availability.

A single platform to allow multiple users to expedite data creation and maintenance

Increased productivity on behalf of underwriters, bond attorneys, and financial advisers and lower costs to the issuers.

Municipalities using public auction sites can bypass underwriting firms.

Extranet architecture substantially reduces mailing and filing costs.

Scalability allows for growing customer base, increased storage date, and future product deployment.

Data accumulated for new issue is available for use when meeting secondary market disclosure obligations.

The present invention offers specific advantages in terms of the secondary market as follows:

Enable complete electronic filing of disclosure materials to the MSRB, NRMSIRs and State Information Depositories (SIDs), making the filing process more efficient, more transparent and more cost effective than traditional paper filing methods.

Preserve the institutional memory of an organization (including a firm acting as dissemination agent).

Fulfill all industry mandated reporting requirements outlined by SEC Rule 15c2-12.

Provide templates that are designed to conform to guidelines set by the National Federation of Municipal Analysts for secondary market reporting.

Provide users with updated reminders of filing obligations and deadlines via email and a task manager to ensure full compliance.

Use of specific data items from the Official Statement (continuing disclosure language, assessed valuation information, top taxpayers, etc.) linked with CUSIP numbers makes completing disclosure reports faster without sacrificing accuracy.

Enabling users to upload Certified Annual Financial Reports (CAFRS) and other supporting disclosure information onto a single system, making data storage and subsequent filings easier and less time consuming.

Permits quick templating of an issuer's disclosure forms, allowing its dissemination agent to file more frequently. Using the upload feature, budgeted financials, recent official statements and updated disclosure information could be submitted on a quarterly basis to repositories and the MSRB as they are for the healthcare sector. Improved investor relations would be the result, as well as an increase in fees for disclosure services.

The inventive method and system relate to both the primary market and the secondary market for securities, with information generated for bond transcripts in the primary market being made accessible for use in continuing disclosure materials, particularly in the form of standardized templates.

The system and method permit the following functionality for securities within the primary market:

creating of disclosure forms associated with new issuance of securities, e.g., prospectus, closing memorandums, purchase contracts, legal opinions.

choosing a disclosure form from templates;

choosing a disclosure form from active issues;

editing a disclosure form in HTML for a new issue;

editing a disclosure form in HTML for a template;

editing of disclosure forms by single user or multiple users;

populating forms with data;

populating templates with data;

generating reports of all or some documents created for a new issue of securities;

The system permits the following functionality for securities within the secondary market:

generating reports of all or some documents created for a new issue of securities;

generating reports that feature selected data;

generating reports that feature market data on various securities;

generating reports featuring economic or demographic data on various securities;

creating a section of disclosure data for a new issue in a central database for use in secondary market reports;

storing a section of disclosure data for a new issue in a central database for use in secondary market reports;

creating updated sections of disclosure data for a secondary issue in a central database for use in secondary market reports;

storing updated sections of disclosure data for a secondary issue in a central database for use in secondary market reports; and

generating annual disclosure reports for securities in the secondary market.

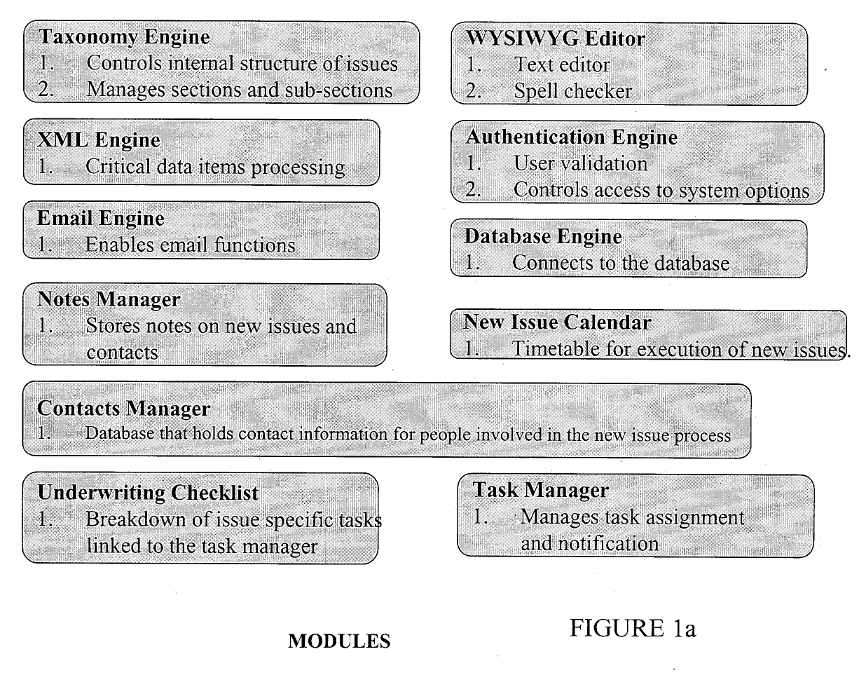

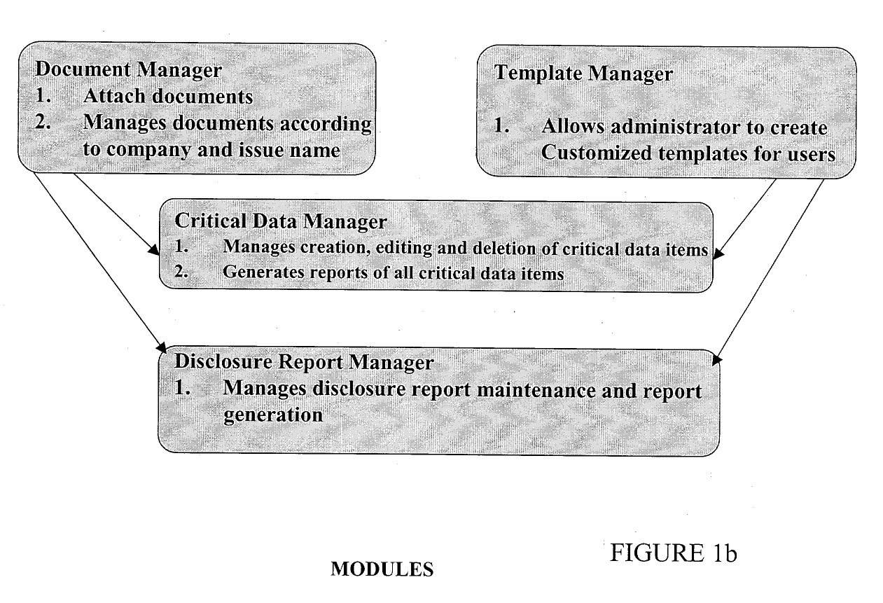

Referring now to FIGS. 1a and 1b, a number of preferred refinements to the system include the use of various modules within the internal interface means. These modules include a taxonomy engine that controls the internal structure of issues and manages sections and subsections of issues, organizes the documents into sections and subsections, tracks ownership of an issue or report and generates the user specific view of documents; a WYSIWYG editor that acts as WYSIWYG (what you see is what you get) text editor and spell checker, generates the document editor interface that allows the user to compose disclosure documents and format reports; an XML engine that handles all critical data item processing and is responsible for merging the HTML document with database content to produce the output requested by the user; an authentication engine that controls validation of user identification and passwords when they log on to the system and controls access to system options based on a user's identification; an email engine that enables email functionality within the system; a database engine that connects the internal interface to the database and handles database connection, data updates, data queries and transaction management.

FIGS. 1a and 1b also show additional modules. The contacts manager includes a contact database that holds name, address, phone, email id information of persons involved in the new issue creation process. This information is linked to individual sections of the new issue allowing users to send emails directly from the edit screens. The task manager manages task assignment and notification, maintains status on individual tasks and flags them when they are overdue.

The notes manager stores notes on new issues and on contacts. This manager includes a notes database that is grouped by users so that each user can have his/her own notes on any new issue or contact. There is also an option of seeing all notes together.

The document manager allows users to attach documents (word files, excel sheets etc.) to any new issue or secondary report, it organizes the documents by Company and by new issue within a company. Also, it manages creation, deletion and copying of documents from the users computer to the server.

The template manager allows the administrator to create and store document templates for each company that registered to do business on the website.

The critical data manager manages creation, editing and deletion of critical data items relevant to a new issue. It also generates a report of all the critical data items related to a new issue.

The disclosure report manager manages Disclosure Report maintenance, as well as CDINET report generation and general report generation.

The new issue calendar is a timetable for execution of the new issue. Individual dates within the calendar are linked to the task manager so that individual items associated with the dates can be completed according to the calendar timetable. An underwriting checklist is provided that also links with the task manager and it breaks down issue specific tasks.

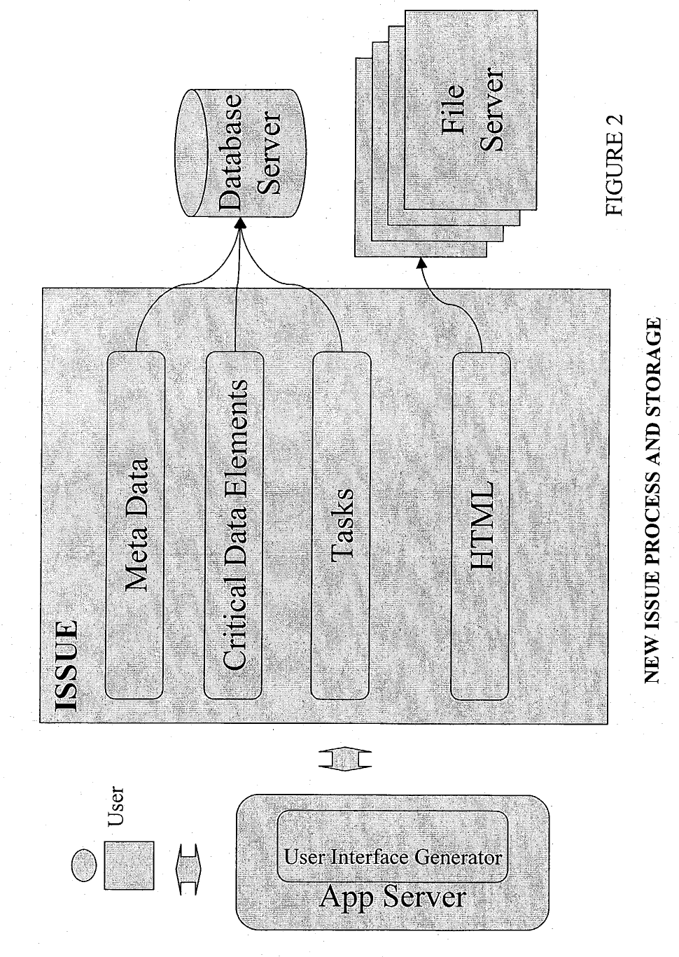

Referring to FIG. 2, the system allows for new issue process and storage of information. When a user is creating, editing or storing information related to a new issue, the system allows for the following activities: creating critical data elements; creating administrative meta data; creating an issue as HTML file; editing critical data elements; editing administrative meta data; editing an issue as HTML file; storing critical data elements on database server; storing administrative meta data on database server; and storing an issue as HTML file on file server.

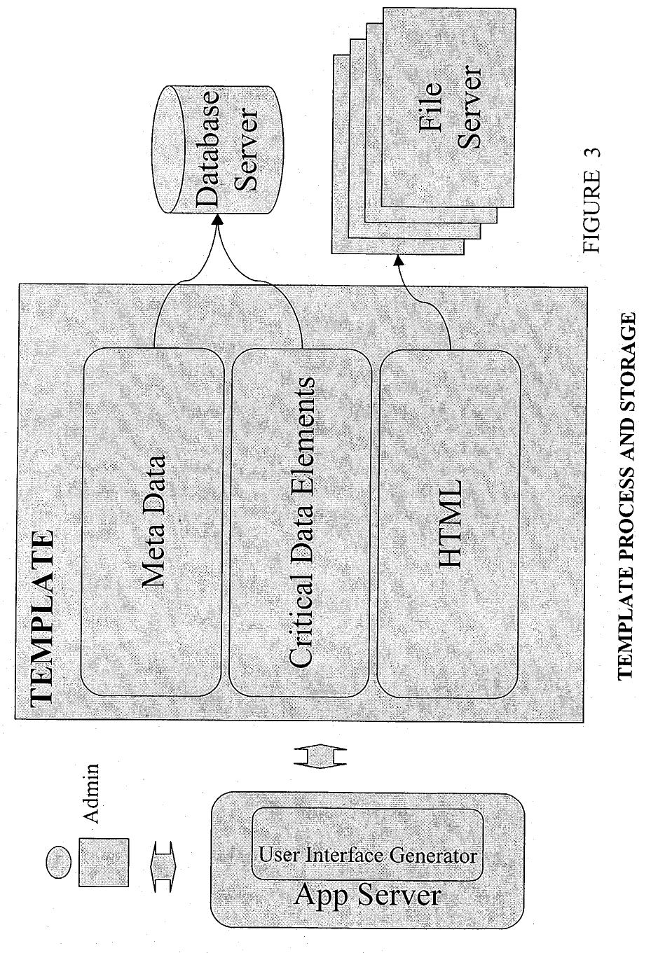

Referring to FIG. 3, the system allows for template process and storage of information. When a user is creating, editing or storing information related to template, the system allows for the following activities: creating critical data elements; creating administrative meta data; creating a template issue as HTML file; editing critical data elements; editing administrative meta data; editing a template issue as HTML file; storing critical data elements on database server; storing administrative meta data on database server; and storing a template issue as HTML file on the file server. The system also allows for creation and editing of tasks via a task manager as is detailed below, the tasks being stored in the central database server.

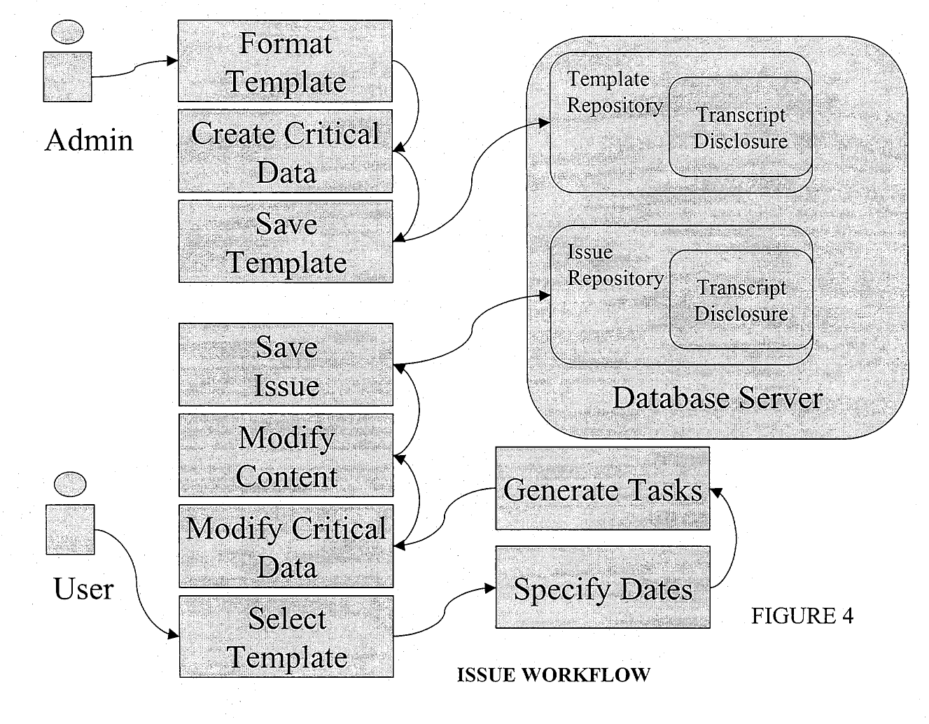

Referring to FIG. 4, the system allows for various workflow processes for administrators as well as regular users. The administrator can set up template disclosure forms by: creating a formatted template; creating content and critical data associated with the template; and storing of template in HTML format in template repository within the central database. Primary market template documents are housed in a transcript section of template repository; secondary market template documents are housed in the Disclosure section of template repository.

A user can work with the templated forms by: choosing a formatted template; specifying dates, and creating/editing tasks, editing a formatted template; editing content and critical data associated with a template; saving the template as a new disclosure form or issue; and storing of disclosure form in HTML format in issue repository within the central database. Primary market disclosure documents are housed in the Transcript section of issue repository; secondary market disclosure documents are housed in the Disclosure section of issue repository.

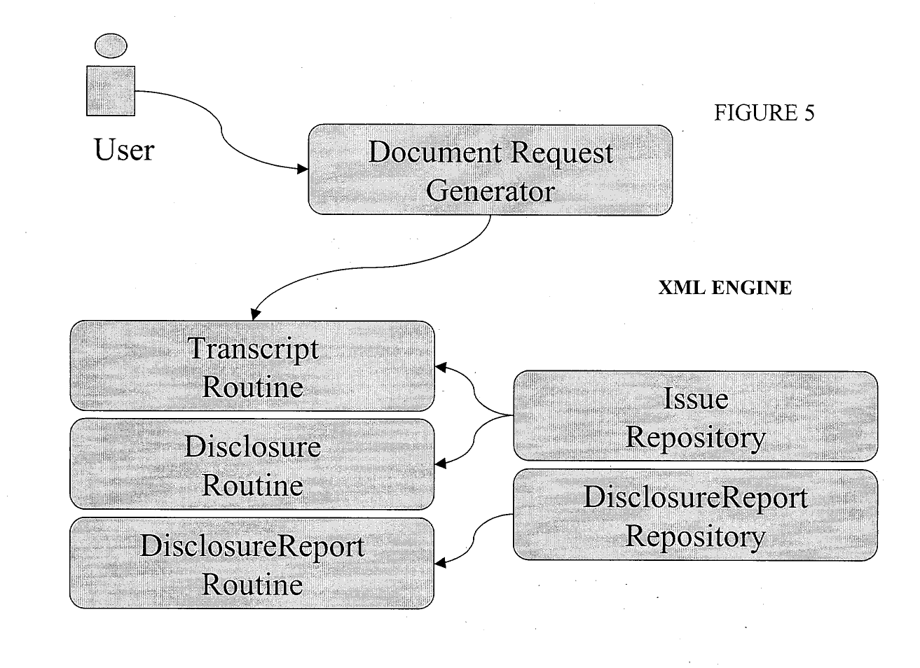

Referring to FIG. 5, the XML engine is responsible for tying together various elements of a bond document to generate the view requested by the user. Within the XML engine there are separate routines to search the Transcript and Disclosure documents. These routines have access to repositories of documents. When a user requests a particular document, these engines access the repository to get information on the document. Using the repository information creates and renders the document in HTML. The repositories contain information in two different formats. One format is the database format. Data elements (called critical data items) are stored in database format in the central database server. The second format is the HTML content and is stored as XML files on the file server. The XML Engine combines both these elements to produce the documents.

There are two different types of documents in the repository. One is a template and the other the actual document. The templates act like boilerplates and speed up the creation of complicated documents. Templates for Disclosure Reports are also stored in the repository.

The XML engine enables the user to insert fields into the HTML documents for easier data-entry and then processes the fields pulling corresponding data from the central database. Critical data items (common terms associated with a new issue of securities) such as beginning interest payment date, interest payment dates, maturity date, issuer name, issuer short name, official statement date, par amount, CUSIP, next year estimate, key financial contact, fiscal year end, issuer telephone number, other tax supported debt, total debt, total overlapping debt, address, BANs, Bond Titles, lease rental/COPS, are linked to corresponding fields within the HTML documents. Data will be populated wherever a field exists throughout the prospectus and other disclosure forms associated with a new issue of securities in the primary market.

When a user is creating or editing a new issue consisting of a prospectus and other disclosure forms associated with a new issue of securities in the primary market, the XML engine pulls corresponding data from the issue repository section of the central database. When a user is creating or editing disclosure forms associated with an issue of securities in the secondary market, the XML engine pulls corresponding data from the issue repository section of the central database. When a user is creating or generating an annual report on a securities issuer, the XML engine pulls corresponding data from the Disclosure repository section of the central database.

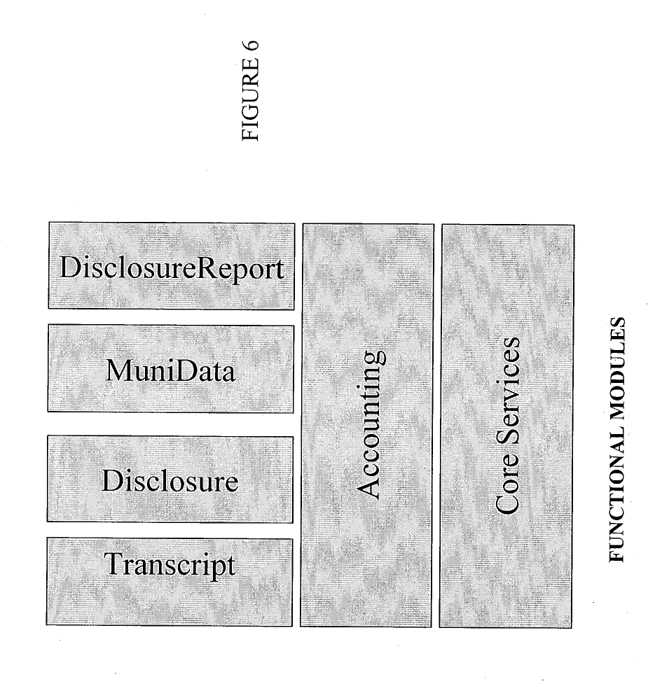

Referring to FIG. 6, the functional modules within the system include specialized software tools: Transcript, Disclosure, MuniData and Disclosure Report; and an accounting module and core service modules (described in FIGS. 1a and 1b). Software tool modules allow users to create, edit, store, disseminate and report disclosure and compliance information for municipalities, institutions and corporations. Transcript is an authoring tool that streamlines the process involved in assembling a prospectus and all other disclosure documentation for a new bond issue. Disclosure is a compliance and dissemination tool allowing users to fulfill secondary market reporting obligations. Disclosure Report is a reporting module that generates reports of bond data in the database and documents stored in the file server. MuniData is a searchable database of market data on bonds in the primary and secondary markets. Preferably, the market data is an accumulation of the critical data items from various issues that are stored in a database. This information can then be accessed for various purposes such as trend identification, general information, and the like.

The accounting module tracks use and handles all billing and accounting-related issues within the system. The core services module houses preferred refinements that users of each software tool can utilize to create, edit, store, disseminate and report disclosure and compliance information.

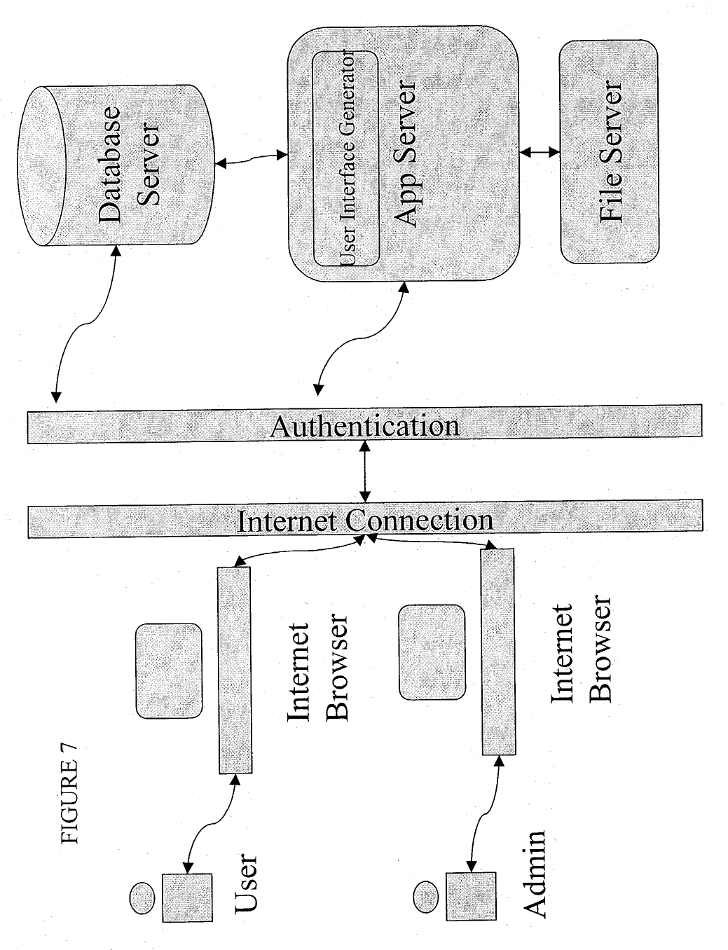

Referring to FIG. 7, the invention is a computerized data processing system for creating, storing, disseminating and reporting disclosure and compliance information for municipalities, institutions and corporations. A central database server and file server receive and process data from users submitting information. Data resides on each server and is in communication with the internal user interface. The internal user interface resides on the application server and communicates with system users, the central database and file server.

A user accesses the internal interface via an Internet connection and a web browser. The web browser interacts with the internal interface through an authentication engine that enhances the security of the system. An internal user interface accesses the central database and file server and transmits data through the web browser to the user.

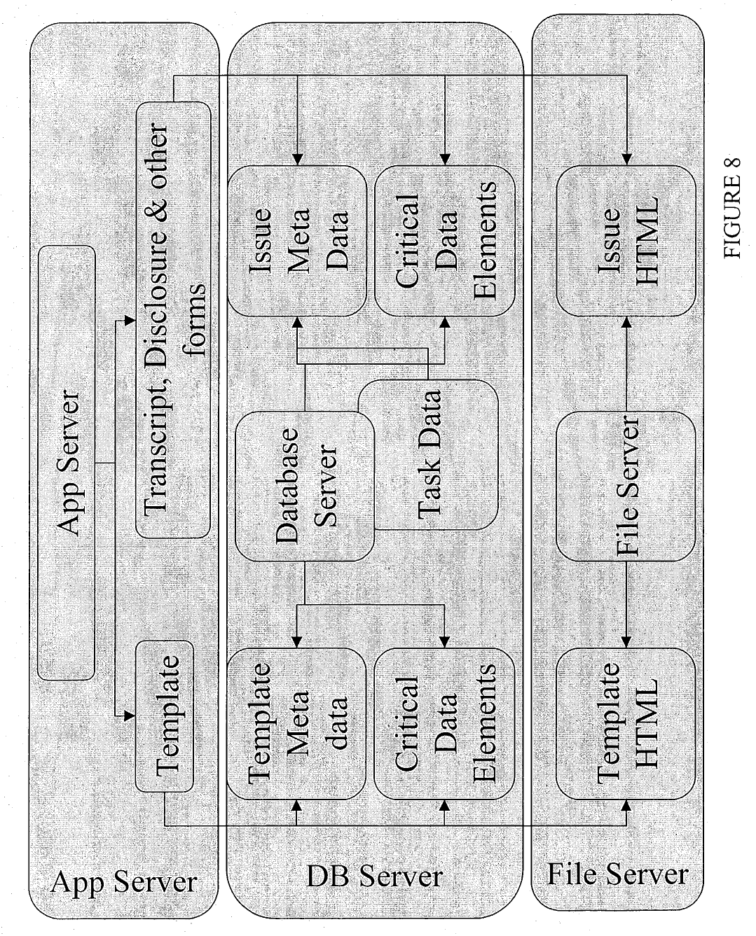

Referring to FIG. 8 and an illustration of the architecture of the system, the system's application server interacts with the file server and the database server. If the user is an administrator and has created a template, the administrative meta data and the critical data elements are stored on the central database server and the document templates in HTML format are stored on the file server. If the user is an administrator and is editing a template, the administrative meta data and the critical data elements are stored on the central database server and the document templates in HTML format are stored on the file server.

If the user is a client and has created a template, the administrative meta data and the critical data elements are stored on the central database server and the document templates in HTML format are stored on the file server. If the user is a client and is editing a template, the issue meta data and the critical data elements are stored on the central database server and the document templates in HTML format are stored on the file server.

If the user is a client and has created a new issue consisting of a prospectus and other disclosure forms associated with a new issue of securities, the issue meta data and the critical data elements are stored on the central database server and the documents in HTML format are stored on the file server. If the user is a client and is editing a new issue consisting of a prospectus and other disclosure forms associated with a new issue of securities, the issue meta data and the critical data elements are stored on the central database server and the documents in HTML format are stored on the file server.

FIG. 8 also shows that the task data that is created as part of a new offering or in connection with disclosure obligations in the secondary market is part of the database server and is linked to the form generation side of the architecture.

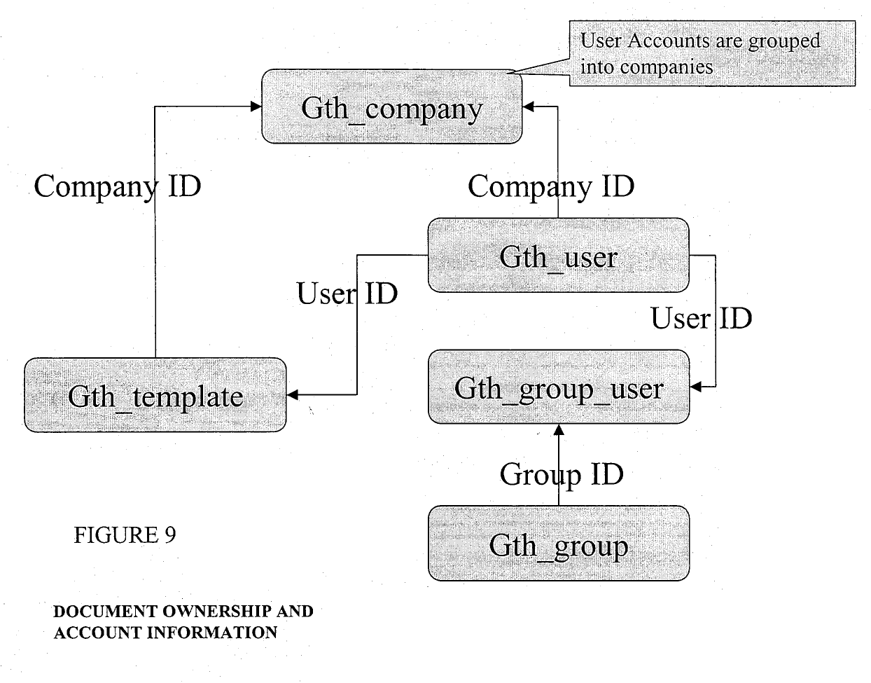

FIG. 9 is an illustration of the system's administrative document ownership and account information protocols within the central database. Individual companies own access to their disclosure documents and templates. Each company has its own system identification and its sub users have individual identifications to allow access to the system and their company's documents and templates within the system.

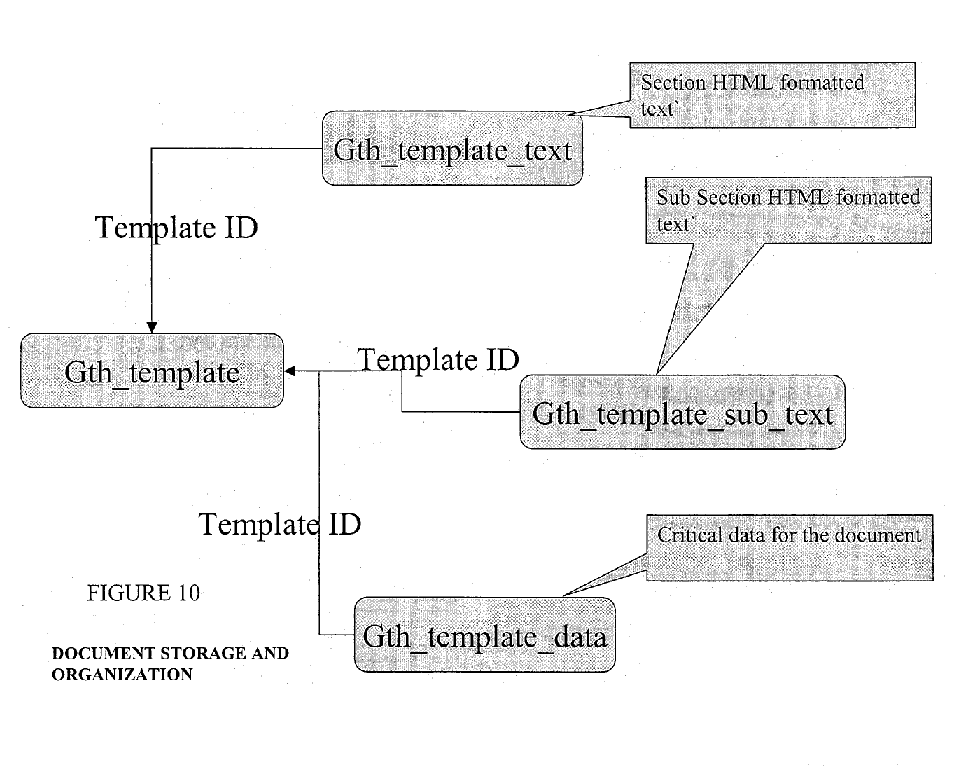

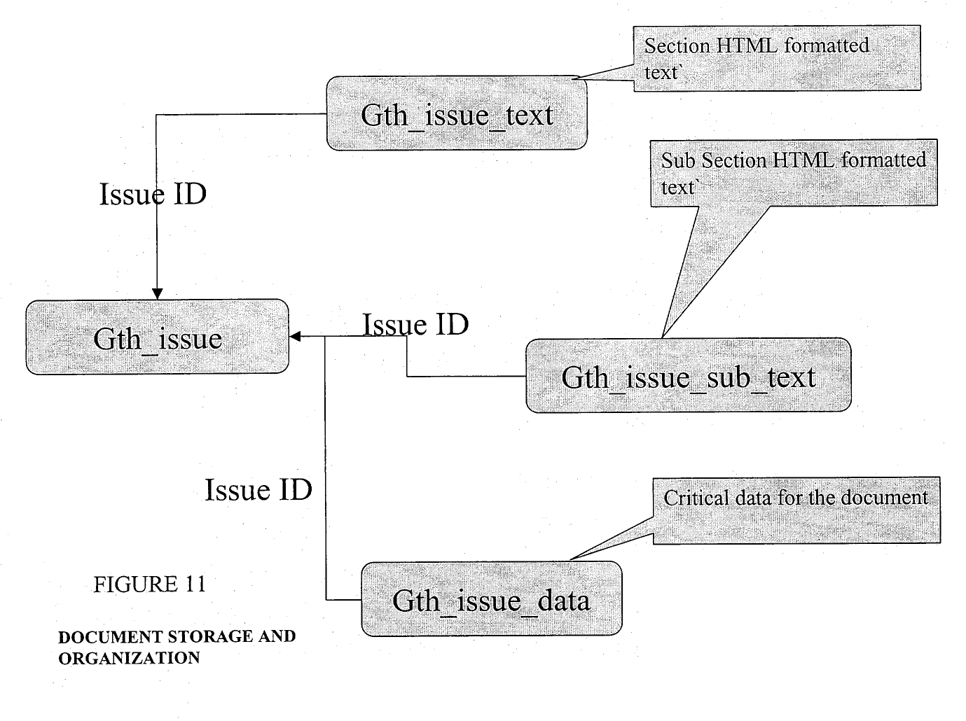

Referring to FIGS. 10 and 11, the system has administrative document storage and organization protocols for templates and bond issues within the central database. FIG. 10 illustrates how a new issue document template is organized and then stored. The template can be broken down into HTML file sections, HTML file subsections and a critical data section. HTML files are stored on the file server; critical data elements are stored on the database server. A valid system administrator user identification allows access to all three sections of data for a particular issue.

FIG. 11 illustrates how a new issue document is organized and then stored. The document can be broken down into HTML file sections, HTML file subsections and a critical data section. HTML files are stored on the file server; critical data elements are stored on the database server. A valid user identification allows access to all three sections of data for a particular issue.

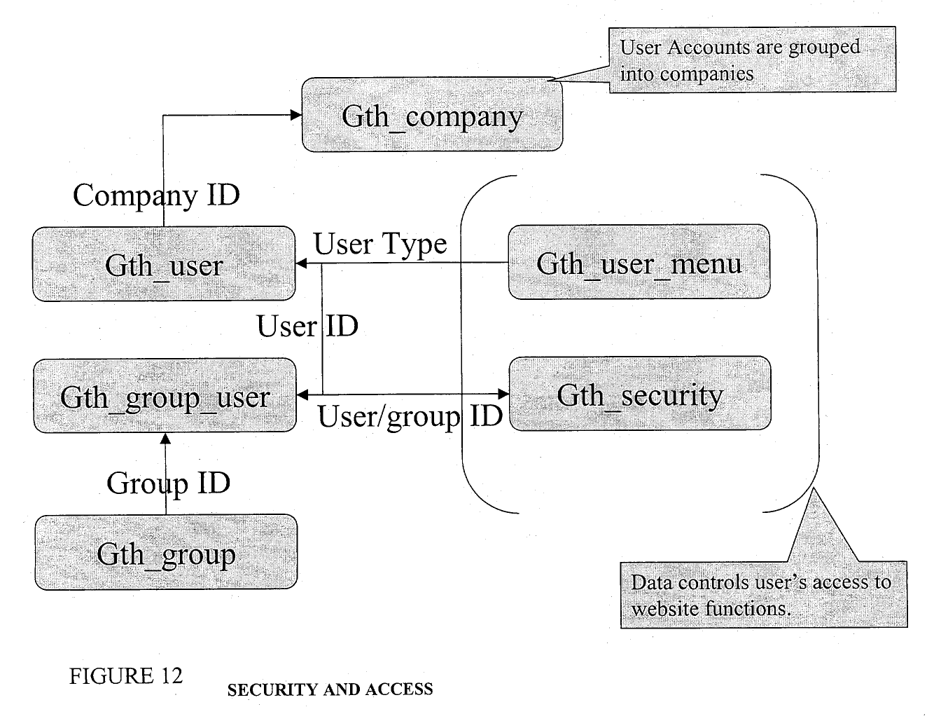

Referring to FIG. 12, the system has administrative security and user access protocols within the central database. Valid user access to the system is determined by the system administrator that sets up user accounts for individual companies and sub user accounts for people within each company. Each company and each sub user will have controlled access to applications within the system. The system administrator defines the options available to the user, including the level of secure access to documents, specific functionality such as editing and previewing of documents, access to subsections of documents and disclosure forms, and the ability to create workgroups of sub users, etc. This authentication system can be any type that will permit a controlled access to the website using tools and techniques such as password and login entry, etc.

All of the security and access data is stored in the database so that the system administrator can effectively monitor security and access of all valid sub users within each company.

Within the disclosure tool, users can upload files in a variety of formats (.xls, .pdf, .doc, .jpeg, .gif, etc.) and store them as part of a specific bond issue. For example, spreadsheets, annual reports, and other files can be included as part of a new issue or a 15c2-12 filing using this feature. Closing memos, G-36 forms, CUSIP forms can all be attached to a specific issue in this way, adding knowledge-management capabilities to the system. This tool could also be used for training new hires in the public finance department, and reducing time spent hunting for electronic files associated with a new deal that might be stored on numerous PCs in the office.

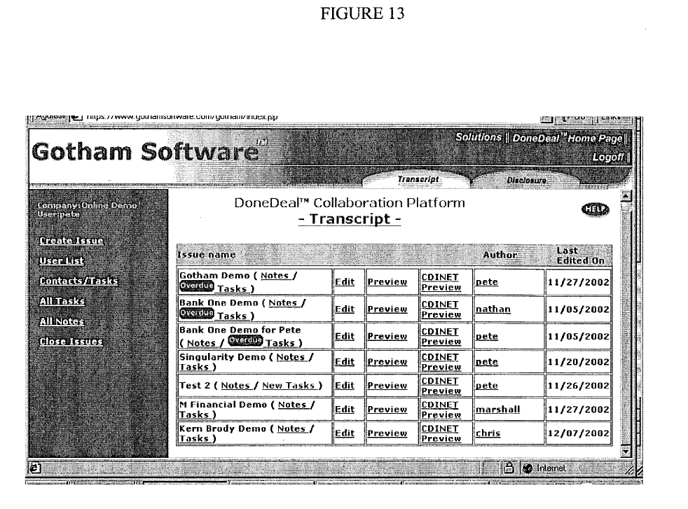

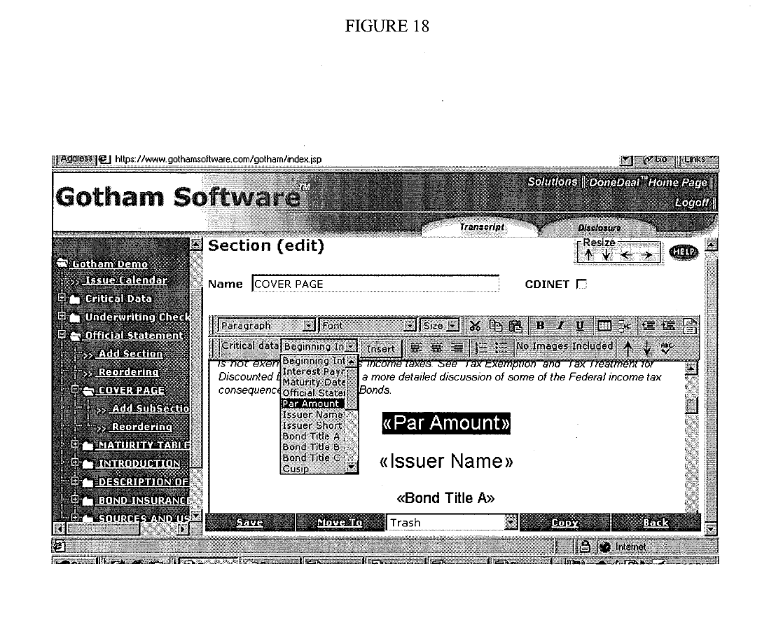

Referring now to FIGS. 13-26, a description of the methods of the invention follows in connection with illustrations of pages that are accessed by the user once properly logged on to the server via the Internet or global computer network. An exemplary home page is shown in FIG. 13. The home page, and entire site for that matter, is split into three panels: a top Banner panel, a main panel and a side navigation panel. The main panel shows a particular user's list of bond issues that they may be working on at the present time. To improve workflow and document tracking, the last author who edited each issue is visible along with the date it was last edited on.

From the main panel, users can: (1) edit an exiting issue (using Transcript) or set of disclosure documents (using Disclosure); (2) preview an existing issue or set of disclosure documents; (3) preview a set of disclosure documents for transmission via a website to the MSRB's Continuing Disclosure Information Network (CDINet); and (4) obtain contact information for the author who last edited the issue, as well as monitor the date of the last series of changes.

From the navigation panel, a user can create a new issue as well, and select from templates of an existing issue or customized templates, and look at Notes and Tasks for a specific issue, and a user list. The templates can be altered by senior people such as administrators, managers, or the like, thus restricting the ability of data analysts to change the template or its wording.

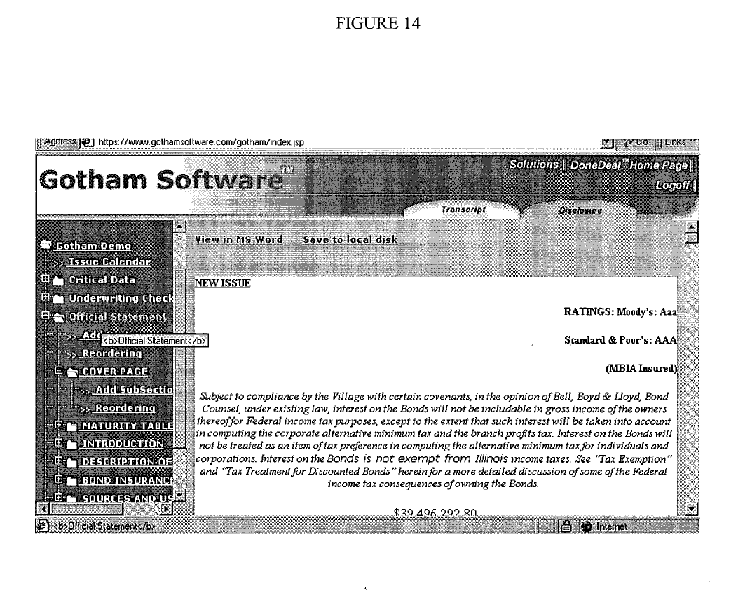

Referring to FIG. 14, a screen as seen by a user is illustrated that reflect opening an existing issue for editing. A navigation panel shows Action Links (Refresh, CD Check List and Delete Issue) as well as a Deal Outline of the existing bond issue (Issue Calendar, Key Dates, Critical Data, Official Statement). Refresh will update bond issues to show recent changes made by a user to specific document sections or to critical data elements. CD Check List will display a list of all critical data fields for an individual bond deal. The navigation panel is illustrated as having selected an Official Statement for viewing, including all supporting transcript documents and forms including closing memos, purchase contracts, CUSIP forms, G-36 forms, etc. The Add Section and Reordering allows users to add new subfolders and move them within an issue. Reordering uses XML technology and greatly minimizes the need for cutting and pasting within the Text Editor. Subfolders with the Official Statement show specific sections of the bond issue.

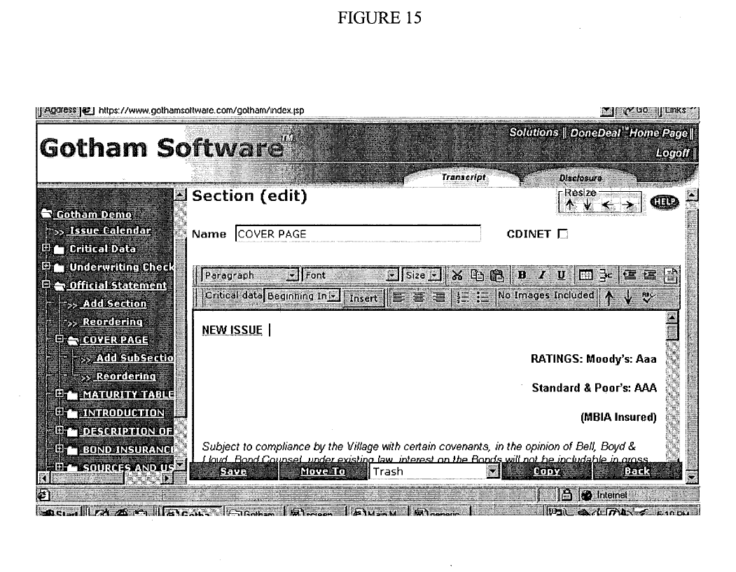

FIG. 15 shows an edit screen for the official statement displayed in FIG. 14. The text editor shown in FIG. 1 allows users to write bond documents in HTML. HTML documents can be easily stored and retrieved from the central database for collaborative use by finance professionals. HTML is also compatible with XML, used to streamline workflow by linking critical data fields within documents to the critical data database as shown below.

To edit text and data within the Official Statement, a user would select a subfolder, select an edit bar at top of the main panel, and the screen in FIG. 14 would appear. The user can add new text, insert tables, update data and format information within the editor using the paragraph styles, fonts, size, alignment and text-style features. The Add Section allows a user to add a new section to the official statement or create a new form. Simply create a name for the new section, then click Save.

To enlarge editing window, click left, right, up or down resize arrows to widen screen for easier editing, click right resize arrow when finished editing before clicking save.

Referring back to FIG. 14, clicking on View in MS Word allows users to convert a section of a document or a whole document from HTML to Microsoft Word® for formatting and printing purposes. Clicking on Save to Local Disk allows users to save sections of documents or complete documents directly to their hard drive. Users need to rename the file to give it a descriptive title before clicking Save.

When documents are in draft form, general document formatting can be done in HTML using the Text Editor. In the drafting process, formatting is less important that generating content and improving workflow. Extensive formatting can slow down the drafting process and is unnecessary until the documents are ready for release to investors.

When the Preliminary Official Statement is ready for release, users can convert bond issues into Microsoft Word® and use proprietary document-formatting techniques specific to an individual underwriter, bond counsel firm or financial advisor.

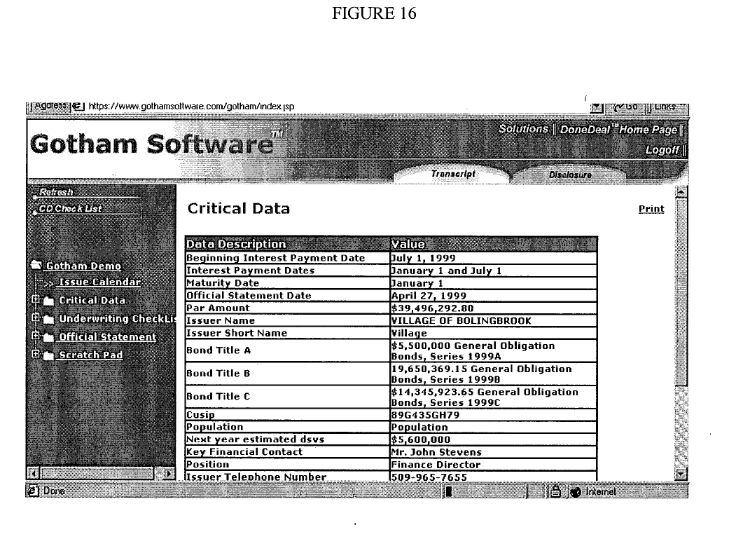

As noted above, the navigation panel also has a critical data folder, and FIG. 16 shows an example of a listing of critical data elements for a particular issue.

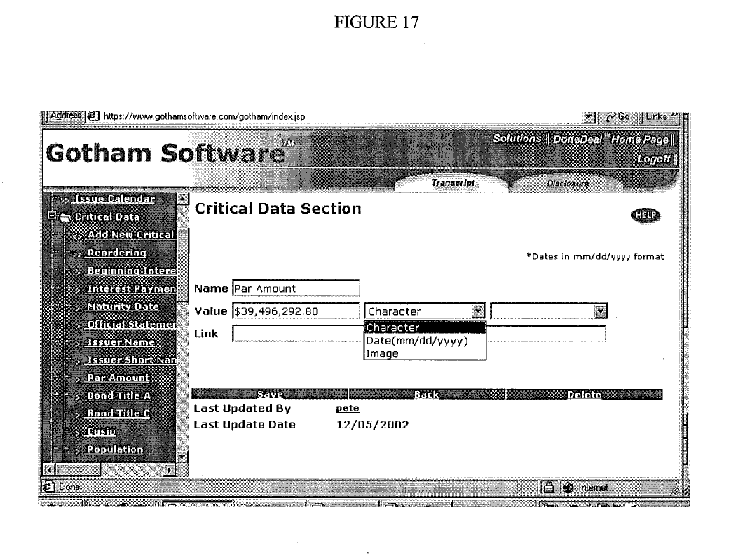

FIG. 17 shows a particular critical data section, i.e., the par amount for the issue. Critical data fields are XML data fields. Each field is stored on the central database and users can insert critical data fields throughout the HTML documents and forms, eliminating “find” and “remove” operations and greatly improving text editing and deal flow. To change or add critical data information, select a critical data folder, then select a critical data field you want to change, or select new to add a new critical data field. This data field will change throughout the Official Statement as well as all supporting transcript data. Select a new value, then click save.

Insertion of a critical data field in a particular document is shown in FIG. 17. A user would open the edit screen as shown in FIG. 15, and, using the critical data pull-down menu, select a critical data field, then place cursor on the screen where the item is to appear and click insert. Users can format their documents and forms using the critical data fields so that each type of document is as standardized as possible, and repetitious data-entry is minimized.

The text editor and critical data fields can be used extensively to format bond issues and supporting forms. Once the documents have been customized for a specific type of financing (general obligation bond, revenue bond, refunding, short-term note) this work can be used on future projects thus improving workflow when working on new deals.

While FIGS. 13-18 relate to the transcript tool wherein new offerings are developed, the same tools are used for the disclosure aspect of the invention.

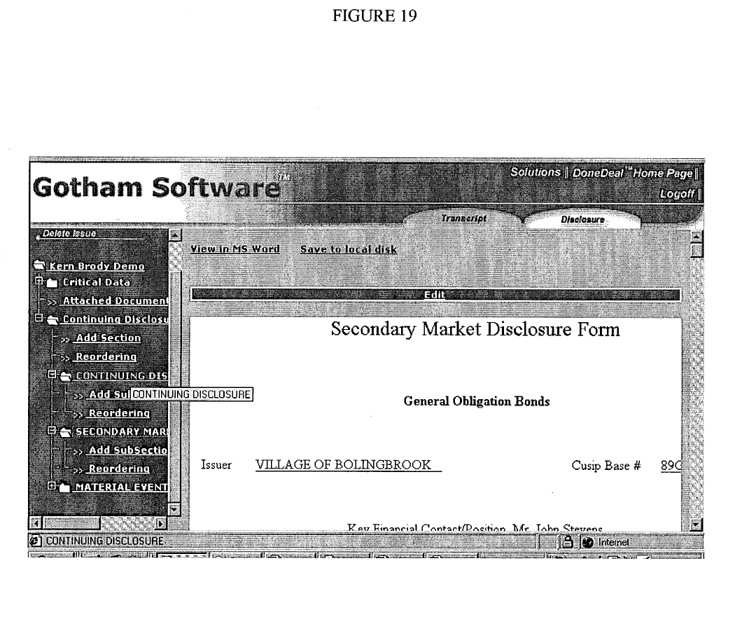

FIG. 19 shows an exemplary screen for Disclosure, wherein the navigation panel identifies: (1) a continuing disclosure heading which outlines specific filing requirements and timeline for a bond issue in the secondary market; (2) a secondary market reporting form which includes information templates recommended by the National Federation of Municipal Analysts (NFMA) to disclose relevant annual information in addition to an annual financial report; (3) a material events notice information template to be completed and filed in the event of a material event (bond call, rating change, default, etc.). As with new offerings, by selecting the edit screen and then the CDINET box in this screen, users can select what information is sent to the MSRB for each year.

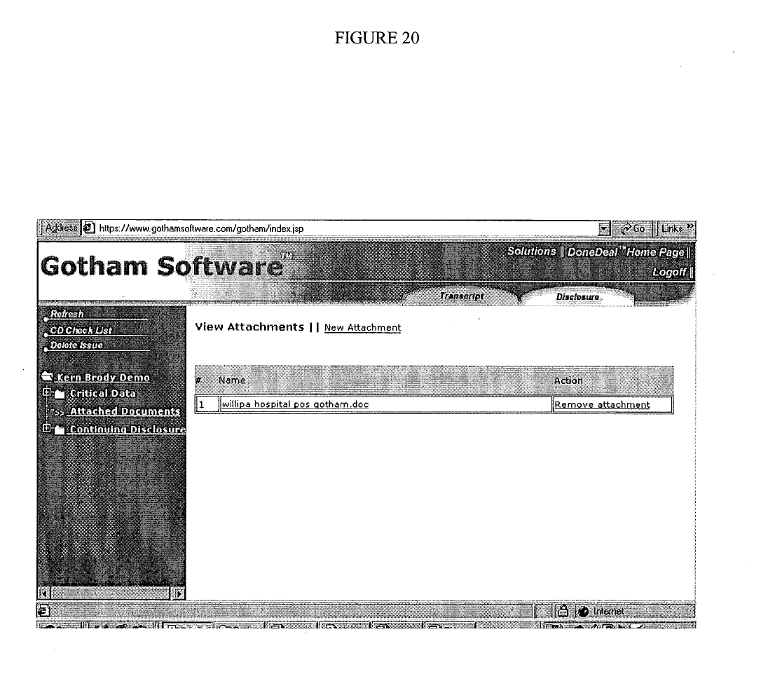

An attach document feature, as part of the Document Manager, is shown in FIG. 20 in connection with the Disclosure aspect of the invention, wherein users can upload files that are associated with a particular new issue or disclosure filing, such as an annual report, budget, environmental impact statement, recent official statement or transcript document. After opening the Attached Documents folder, users can attach a new file to an issue or disclosure filing by selecting New Attachment and then uploading the file from the hard drive or other source. Users can also remove files by selecting Remove File. Of course, this feature can also be used when developing new offerings as well.

Besides the ability to create, edit and disseminate information/forms for new offerings and existing offerings, the invention also includes a new issue calendar, an underwriting checklist, and task management capabilities.

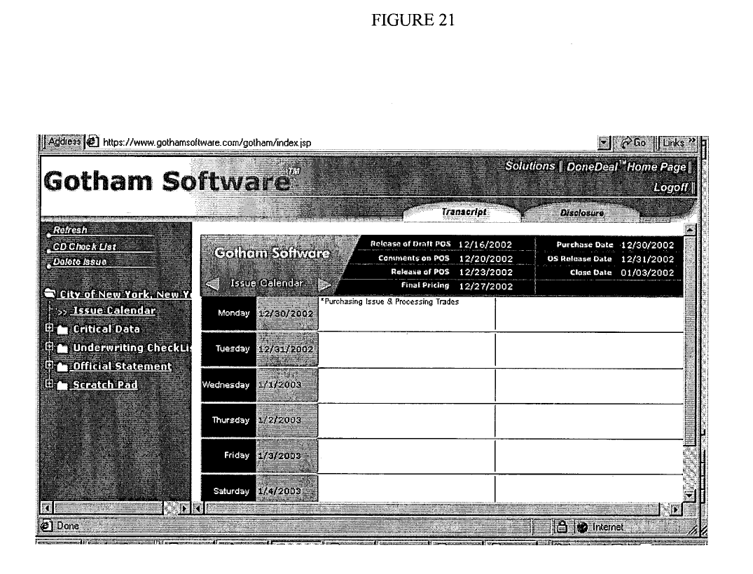

A new issue calendar as shown in FIG. 21 outlines the critical tasks required for each deal and provides a timeline in the form of a calendar segment for the tasks to be carried out in accordance with internal office and MSRB regulated deadlines. The critical tasks can be changed, and these changes will be newly displayed in the Issue Calendar and in the Checklist where appropriate, see below. Various members of the finance team, including corporate trust agents, could login to the system to track the status of closing dates for various deals, documentation and tasks and activities related to new deals. Each timeline box can include information as to whether a particular task is met.

To change the timeline for a deal, or the title of the deal, a user would select the Issue Title link at the top of the main folder list in the Navigation Panel, i.e., Gotham demo in FIG. 14. A screen would pop up as an edit mode, and the user could change the title of the deal and any of the Key Dates, then save the changes. The saved changes would then appear on the issue calendar.

The Issue Calendar will reflect the changes just made to the bond schedule, notifying everyone working on the new deal that the timeline has been adjusted.

By selecting the Issue Calendar link, i.e., from the Navigation Panel, see FIG. 14, the user will see the calendar listing deal activities and Key Dates, seven important dates associated with registering a new bond issue as shown in FIG. 21. These dates determine the timeline for any new deal. Specific activities must be completed in accordance with the Key Dates for the new issue to be completed in a timely manner.

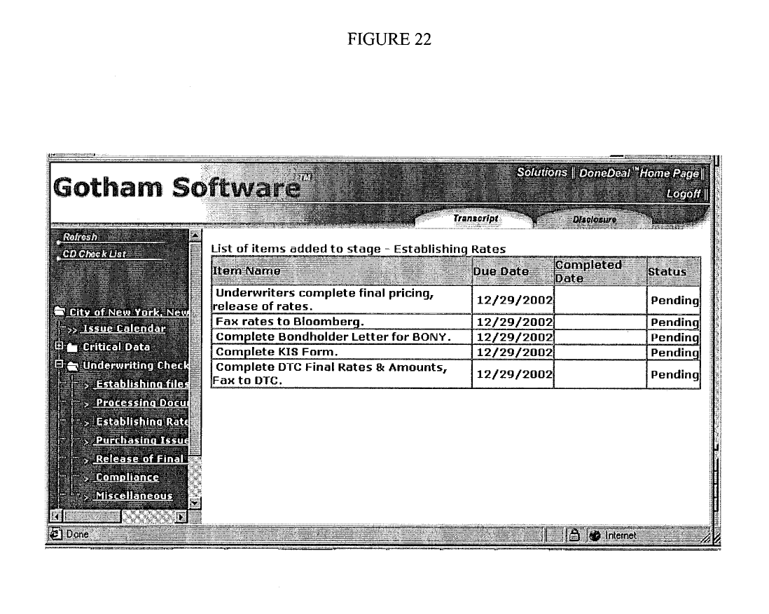

An underwriting checklist as shown in FIG. 22 provides the operations department, the underwriter, FA and bond counsel and other viewing this display with a detailed outline of various stages of the new issuance process. This can be customized for individual institutions. This list of critical tasks in the checklist provides a complete template to managing a deal, filing all the necessary paperwork, regulatory forms, completing OS mailings, processing trades, etc. This list can be customized for individual clients an their internal methods for doing deals, but will serve as an excellent template for most underwriters and FAs, and could greatly improve the underwriting process for some firms.

When a new issue is created, the underwriting checklist for the deal can be created as well, and can be assigned to a specific member of the working group (usually someone in the operations department of the lead underwriter).

The underwriting checklist is located underneath the Critical Data Folder and includes a list of specific activities (39 tasks in all is one example) that must be completed for any new bond issue to be underwritten and to be in compliance with US securities laws and regulations. The Checklist is broken down into 7 sections that correspond to the 7 Key Dates shown in the Issue Calendar. These activities populate the task management system, see below, as well as the underwriting checklist.

By selecting sections of the Underwriting Checklist, users can see what tasks need to be completed for each stage of the underwriting process.

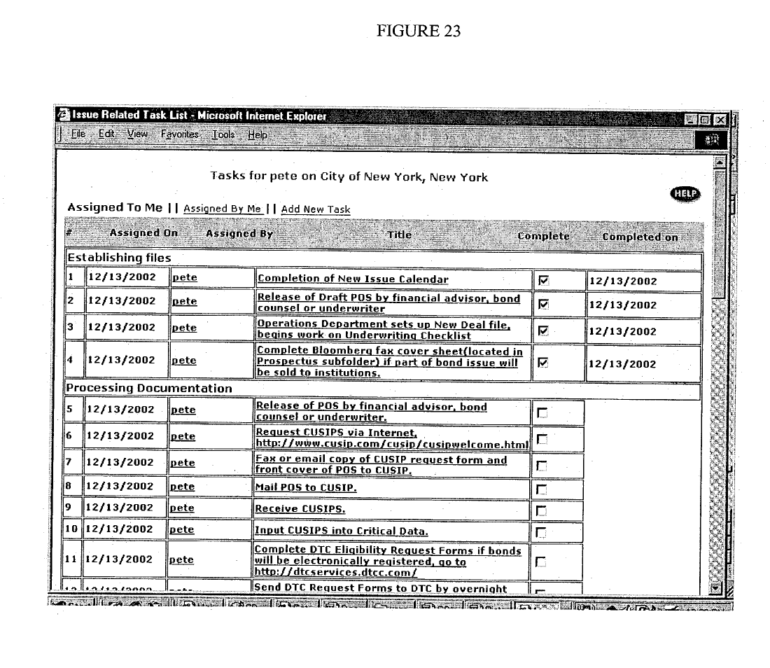

A task manager as shown in FIG. 23 provides a way to assign and monitor time-sensitive activities for a new deal or managing secondary reporting tasks and deadlines. The task manager system allows users to create task lists both for themselves and for other participants who are registered as users of the system. It can make issuers and firms much more accountable and transparent, and improve internal compliance procedures and monitoring. Note that the taskbar has three options: assigning new tasks, viewing tasks assigned to you, and viewing tasks assigned by you to someone else on the finance team.

The task manager allows tracking of completed and incomplete tasks, thus improving compliance and transparency. If someone has been assigned a task (such as filing secondary market information for a particular issuer based on the deadline outlined in the Continuing Disclosure section of the Official Statement), they can click “complete” for a specific task, then click ok in the pop up box, and ok at the bottom of the task window. By selecting “All Tasks” from a Home page, completed tasks appear with a time and date stamp next to it, verifying completion.

Exemplary elements that can be included in the tasks manager include, the date the task was assigned, the target completion date for the task, a title for the task, a description of the task, the bond to which the task is referring, a list of all tasks for a company, a system to announce and track the completion of tasks, and a highlighting to announce to a user that they have been given a new task for a particular bond.

To view all the tasks for your company, click the All tasks link on the side navigation panel, see the FIG. 13. This will open a new browser window that lists all of the tasks assigned within your company, FIG. 23. The information provided on the tasks is: (1) task number; (2) bond title to which task is connected; (3) the date the task was assigned; (4) who assigned the task; (5) to whom the task was assigned; (5) the title of the task; and (6) whether the task has been completed, and if yes, the date of completion.

By selecting tasks for a specific issue on the Home Page, users can see what tasks have been completed for each stage of the underwriting process, and what tasks remain to be done. By selecting Complete, the system prompts the user to verify the task has been completed, then assigns a date stamp to the task. In this manner, the task management system can be used as a compliance tool by a firm's compliance department to monitor internal compliance.

Overdue tasks can appear in a number of ways in the system. For example, on the Home Page, see FIG. 13, a blue overdue marker can be placed next to a specific bond deal.

Alternatively, tasks in the task manager can be highlighted in red. For example, the “RECEIVE CUSIPS” under processing documentation section in the underwriting checklist could be highlighted in red to indicate that this task is overdue. This feature will improve workflow as well as a firm's internal compliance procedures associated with new offerings.

The system and method also include a contacts manager. This module keeps not only company-wide contacts with access to current and previous deals controlled by the company administrator, but also allows individual users to add private, personal contacts and notes associated with each contact. This flexibility allows participants to keep contacts important to their work on a deal in the system without needing to give those contacts access to the system.

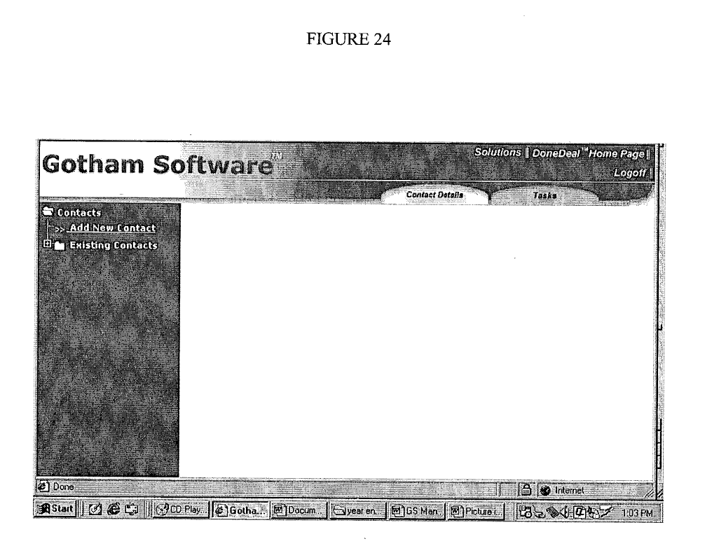

To enter the contact manager module from the Home Page select the Contacts/Tasks link on the side navigation panel from the Home Page, see FIG. 13. A screen, see FIG. 24, pops up showing folders in a side panel to add new contacts or access existing contacts. In contrast to previous illustrations, see for example FIG. 13, upon entering the Contact/Task module, the top banner changes from the Transcript and Disclosure tabs to Contact Details and Tasks tabs; otherwise the panel is the same as in the other modules. The current tab remains the white highlighted tab, in this case Contact Details. As noted above, the side navigation panel has options to Add New Contact and view Existing Contacts.

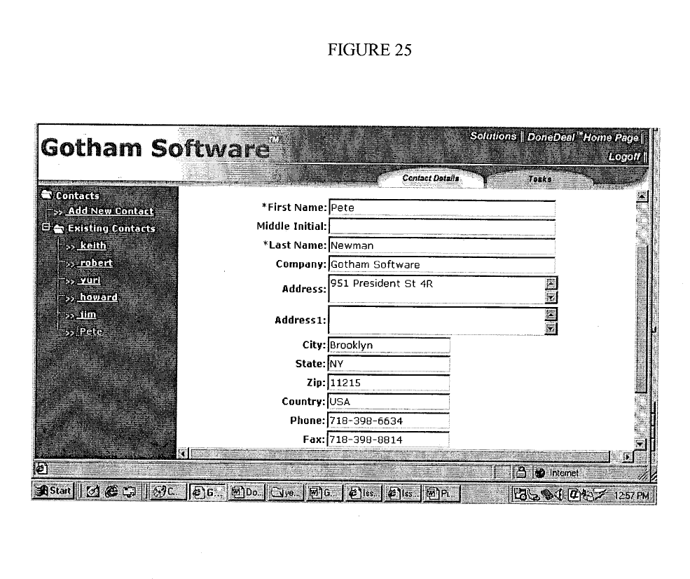

Clicking Existing Contacts will show a list of all contacts currently in your system. FIG. 25 shows the side panel with listed contacts, and an exemplary contact. The contacts come in different colors, with those in one color being company-wide contacts; with those in another color being the logged-in user's private, personal contacts.

Clicking on the name of one of the listed contacts brings up the information stored in the system on that contact. From this page an email may be sent to this contact. To do so, click on the Send Mail link found near the bottom left-hand side of the Main Panel.

To add a new personal contact a user clicks on Add New Contact and adds the appropriate information for the contact in the corresponding rows. To complete, the save button is clicked at the bottom of the Main Panel. To clear all of the fields, click the cancel button.

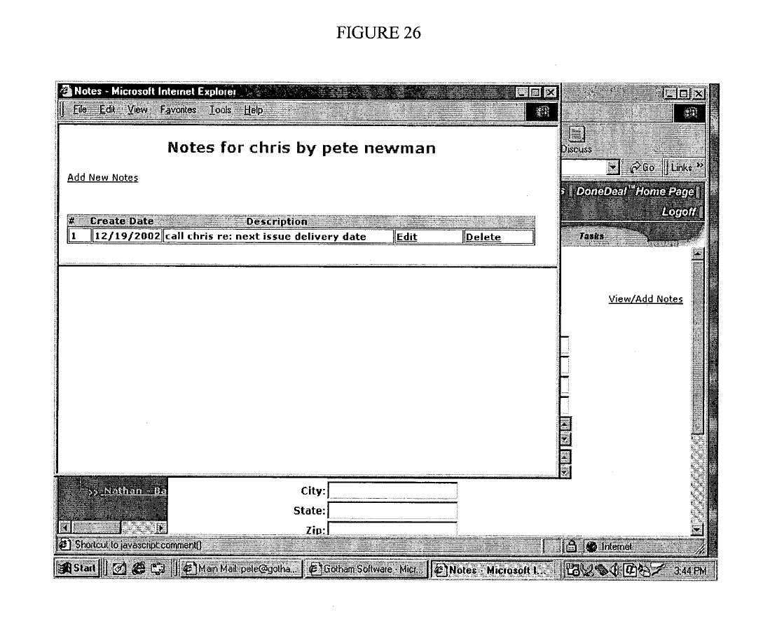

Referring back to FIG. 13, the home page also shows an All Notes link in the navigation side panels, and a Notes link for each of the named issued. Clicking on All Notes reveals a listing of all Notes made, similar to the display for all tasks. Alternatively, clicking on the link for a particular issue will display notes associated with that issue and the user that is logged on. Notes can be viewed or added in conjunction with a particular page. For example, and as shown in FIG. 26, selection of a particular contact page will display a View/Add Notes link, and clicking on this link will display the note page showing a note created on Dec. 19, 2002. The note page also has a link to add notes.

As such, an invention has been disclosed in terms of preferred embodiments thereof which fulfills each and every one of the objects of the present invention as set forth above and provides new and improved system and methods for electronic securities underwriting and electronic dissemination of annual financial and disclosure information from issuers to information repositories in accordance with U.S. securities laws and regulations.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. A method for electronic underwriting of new offerings of securities in the primary market in accordance with US securities laws and regulations for municipalities, institutions and corporations comprising:
a) providing at least one server and a central database, the central database containing a plurality of forms as new offering templates and active new offering forms, the forms containing a number of data fields and content;
b) providing an internal user interface in communication with the server;
b) accessing the internal user interface via a global computer network using one or more authentication steps followed by at least one user;
c) selecting one of the forms;
d) editing the selected form with one or more of data input from the at least one user or data stored on the central database;
e) storing the form on the central database for later editing or later dissemination to an interested party or the at least one user.

2. The method of claim 1, wherein the editing comprises one or more of adding data fields to the form and entering data therein, inputting data into existing data fields in the form, or editing content of the form.

3. The method of claim 1, wherein a number of forms are edited and stored for a given new offering.

4. The method of claim 1, wherein the plurality of forms further comprise one or more of a closing memoranda, a preliminary official statement, a final official Statement, a G-36 form, a legal opinion, and a purchase contract.

5. The method of claim 1, wherein a number of users access the form for editing

6. The method of claim 1, wherein common data fields are populated with data when data is input into one data field of the common data fields.

7. The method of claim 1, wherein the form is derived from critical data elements for inclusion in the data field and being stored in a database format and content files stored on a file server in HTML, wherein an XML engine combines the content files and critical data elements to produce the form.

8. The method of claim 1, further comprising:
(i) providing a plurality of disclosure forms in the central database, the disclosure forms having information required once a new offering is completed;
(ii) selecting one of the disclosure forms related to the completed new offering;
(iii) editing the disclosure form using at least data stored on the central database related to the completed new offering; and
(iv) storing the edited disclosure form on the central database for dissemination to an information repository.

9. The method of claim 8, further comprising electronically disseminating the edited disclosure form to an information repository.

10. The method of claim 9, wherein the information repository includes the Securities and Exchange Commission (SEC), the Municipal Securities Rulemaking Board (MSRB), Nationally Recognized Municipal Securities Information Repositories (NRMSIRs), and State Information Depositories (SIDs).

11. A method for electronically compiling and disseminating annual financial and disclosure information for existing offerings of securities in the secondary market in accordance with U.S. securities laws and regulations for issuers of securities such as municipalities, institutions and corporations comprising:
a) providing at least one server and a central database, the central database containing a plurality of disclosure forms in the central database, the disclosure forms having information required for the existing offering;
b) providing an internal user interface in communication with the server;
b) accessing the internal user interface via a global computer network using one or more authentication steps followed by at least one user;
c) selecting one of the forms;
d) editing the disclosure form using at least data stored on the central database related to the existing offering; and
e) storing the form on the central database for later editing or later dissemination to one or more of the at least one user or an information repository.

12. The method of claim 11, wherein the information repository includes the Securities and Exchange Commission (SEC), the Municipal Securities Rulemaking Board (MSRB), Nationally Recognized Municipal Securities Information Repositories (NRMSIRs), and State Information Depositories (SIDs).

13. The method of claim 11, wherein the disclosure form is a secondary market disclosure form, a material event notice, an annual financial report, and a financial earnings report.

14. The method of claim 11, wherein the editing comprises one or more of adding data fields to the form and entering data therein, inputting data into existing data fields in the form, or editing content of the form.

15. The method of claim 11, wherein a number of forms are edited and stored for a given new offering.

16. The method of claim 11, wherein a number of users access the form for editing.

17. The method of claim 11, wherein common data fields are populated with data when data is input into one data field of the common data fields.

18. The method of claim 11, wherein the form is derived from critical data elements for inclusion in the data field and being stored in a database format and content files stored on a file server in HTML, wherein an XML engine combines the content files and critical data elements to produce the form.

19. The method of claim 1, further comprising establishing a plurality of tasks to be completed in conjunction with the new offering, and displaying the tasks based on task due date, completion date, and status for tracking purposes.

20. The method of claim 11, further comprising establishing a plurality of tasks to be completed in conjunction with the new offering, and displaying the tasks based on task due date, completion date, and status for tracking purposes.

21. The method of claim 1, further comprising establishing a plurality of tasks to be completed in conjunction with the new offering, displaying the tasks with a timeline for identifying task completion.

22. The method of claim 11, further comprising establishing a plurality of tasks to be completed in conjunction with the new offering, displaying the tasks with a timeline for identifying task completion.

23. The method of claim 1, further comprising establishing a plurality of tasks to be completed in conjunction with the new offering, assigning the tasks to an individual from another individual, and displaying one or more of the tasks based on task due date, the task status, the individuals associated with assigning, the task subject matter of the task, and the new offering.

24. The method of claim 11, further comprising establishing a plurality of tasks to be completed in conjunction with the new offering, assigning the tasks to an individual from another individual, and displaying one or more of the tasks based on task due date, the task status, the individuals associated with assigning, the task subject matter of the task, and the new offering.

25. A computerized system for electronic underwriting of new offerings of securities in the primary market in accordance with US securities laws and regulations for municipalities, institutions and corporations and electronically compiling and disseminating annual financial and disclosure information for existing offerings of securities in the secondary market in accordance with US securities laws and regulations for issuers of securities comprising:
a user interface means for creating, editing, and disseminating information relating to new offerings and annual financial and disclosure information relating to existing offerings of securities;
server means for storing said created and edited information in a central database supported by said server;
said server means for processing user input and user commands for creating, editing, and disseminating the information, the user interface means in communication with said server means for completing the information and delivering dissemination requests to said server means;
said server means having means for delivering to said user interface means the created and edited information stored in said central database;
means for allowing simultaneous access to said server means through said user interface means by a plurality of users; and
said user interface means having electronically linked data fields means connecting to said server and said central database.

26. The system of claim 25, wherein said server means is capable of responding to said user requests and deliver dissemination reports to outside repositories, agencies, institutions and other third parties.

27. The system of claim 25, wherein said user receives electronic verification from the system once server means have responded to said user requests for delivery of dissemination reports to outside repositories, agencies, institutions and other third parties.

28. The system of claim 25, including storage of electronic verification information in the central database.

29. The system of claim 25, including said server means responding to said user requests for compliance reports of electronic verification information in the central database.

30. The system of claim 25, wherein the server further comprises:
a) a central database server and a file server, wherein data elements for creation of information are stored in the central database server, and documents for receiving the data elements for creation of the information are stored on the file server.

31. The system of claim 25, wherein the central database server stores templates related to new offerings and created information relating to new offerings and existing offerings, information related to new offerings accessible via the user interface means for creation of information related to existing offerings.

32. The system of the claim 25, wherein the information created, edited, stored, and disseminated by the user interface means includes templates, templates with one or more of added or edited data elements, and existing offering forms with one or more of added or edited data elements.
